(19) United States
(12) Patent Application Publication
(10) Pub. No.: US 2011/0110587 A1
(43) Pub. Date: May 12, 2011

(54) Generating Harmonic Images

(76) Inventor: Ron Banner, Haifa Israel (IL)

(21) Appl. No.: 12/617,183

(22) Filed: Nov. 12, 2009

(51) Int. Cl. G06K 9/00

(52) U.S. Cl. 382/167

(57) ABSTRACT

A computer implemented method of generating a harmonic image based on object data defining a plurality of objects to be located in the image, and location data defining a plurality of locations in the image, the method comprising the steps of: determining a plurality of harmonic object-location pairs from a plurality of possible object-location pairs; and, generating an image according to the determined harmonic object-location pairs.

### BACKGROUND

Placement or arrangement of visual elements may be performed according to a specified color scheme. For example, three popular color schemes are the complementary color scheme, the triad color scheme and the analogous color scheme.

One property of color which distinguishes one color from another is termed color hue and is dependent on the dominant wavelength of light that is emitted or reflected from an object. For example, the range of visible light is generally between infrared light (approximately 700 nm wavelength) and ultraviolet light (approximately 400 nm wavelength). In addition to color hue, the properties of a color include saturation and luminance. For purposes of brevity, the terms ‘color hue’, ‘color’ and ‘hue’ are used interchangeably within the description to denote color hue.

FIG. 1 shows a color wheel 100 which provides an organisation of colors around a circle. Primary, secondary and tertiary colors are marked P, S and T respectively. Colors that are opposite to each other on the color wheel 100 are termed complementary colors. For example, red 101 and green 107 or yellow-orange 110 and blue-violet 104 are complementary pairs. When two colors forming a complementary pair are placed side by side in an image, they appear to vibrate, draw attention to the element and produce tension to the image. Complementary schemes are often used as a perceptual tool to stress important objects or deliver a message.

A triadic color scheme uses colors that are evenly spaced around the color wheel 100. For example, in FIG. 1 the colors violet 103, orange 111 and green 107 are spaced with three colors between them, thus constituting a triad scheme. The contrast between triad colors is not as strong as that between complementary colors, but these colors are considered to be more pleasing to the eye. The three colors in a triad scheme often balance each other and avoid the tension that is produced by complementary color schemes.

Analogous color schemes refer to colors which are close on the color wheel 100. For example, red-violet 102, violet 103, blue-violet 104 and blue 105 constitute an analogous color scheme denoted 113. Analogous color schemes are a palette of compatible color combinations that blend well together and typically provide aesthetically pleasing results in terms of human visual perception. Unlike the complementary and triadic color schemes that often create tension in the image, analogous color schemes suggest tranquillity and calmness.

The triad and complementary color schemes are derived from a family of remote color composition schemes. This is in contrast to the analogous color scheme which is based on close colors. Thus, whilst the triad and complementary color schemes may be selected on the basis of artistic intent, the analogous color scheme may be used merely as an attractive visual property which leads to an inherently appealing image, independent of artistic intent.

Colors can be represented using a mathematical model termed a color space whereby a color is represented as a tuple of numbers, typically termed values, components or coordinates. Typically, a color space represents a color as three or four coordinates, as is the case for the well known RGB, CMYK and CIELAB color spaces. For example, the CIELAB color space represents color using the three coordinates L*, a* and b*, where L* represents color lightness, a* represents color position between red-magenta and green, and b* represents color position between yellow and blue.

### BRIEF DESCRIPTION OF THE DRAWINGS

Features and advantages of the invention will become apparent from the following description of embodiments of the invention, given by way of example only, which is made with reference to the accompanying drawings, of which:

FIG. 1 shows a color wheel illustrating complementary, triad and analogous color schemes.

FIG. 2 shows an image comprising a plurality of locations, and a plurality of objects to be placed in the image in accordance with a first embodiment of the present invention.

FIG. 3 shows a bipartite graph of object and location nodes in accordance with a first embodiment of the present invention.

FIG. 4 shows a flow diagram illustrating a computer implemented method for producing an image in accordance with a first embodiment of the present invention.

FIG. 5 shows an image comprising a plurality of locations and color entities, and a plurality of objects to be placed in the image in accordance with a second embodiment of the present invention.

FIG. 6 shows a bipartite graph of object and location nodes in accordance with a second embodiment of the present invention.

FIG. 7 shows a flow diagram illustrating a computer implemented method for producing an image in accordance with a second embodiment of the present invention.

FIG. 8 shows an image comprising a plurality of locations and color entities, and a plurality of objects to be placed in the image in accordance with a third embodiment of the present invention.

FIG. 9 shows a flow diagram illustrating a computer implemented method for producing an image in accordance with a third embodiment of the present invention.

FIG. 10 shows a graphical user interface (GUI) for producing an image in accordance with a fourth embodiment of the present invention.

FIG. 11 shows a computing device for producing an image in accordance with embodiments of the present invention.

### DETAILED DESCRIPTION

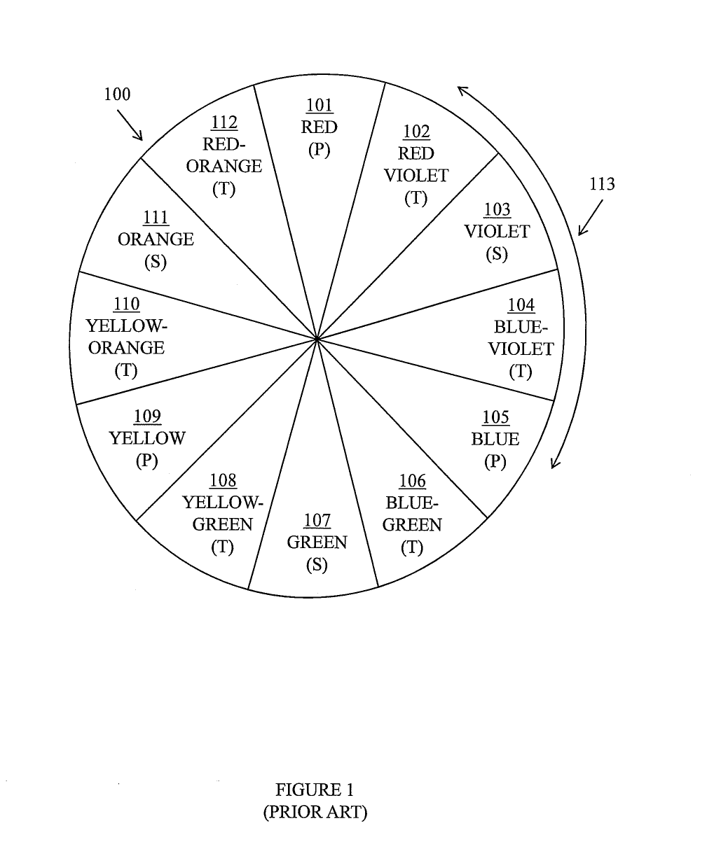

When placing one or more objects into an image, it is often desirable to locate the objects such as to achieve a harmonic composition on the basis of a chosen color scheme. Analogous color schemes are known to exhibit stability and robustness with respect to remote color schemes such as the triad and complementary schemes. The robustness of analogous color schemes can be demonstrated by changing the hue of a dominant color in an image generated or composed according to a particular color scheme. For example, shifting the hue by 30 degrees or one segment of color wheel 100 of FIG. 1 in an image generated or composed according to a remote color scheme such as the triad or complementary scheme results in a relatively pronounced change to the overall image as perceived by a viewer. However, a similar change to a dominant color in an image generated or composed according to an analogous color scheme results in a relatively imperceptible change. Thus, employment of analogous color schemes is highly attractive for the robust computing of aesthetic color combinations.

When considering harmony of an image I, it is helpful to introduce a quantitative measure of harmony. This can be achieved by defining a hue standard deviation 0σ_{c,r}(I) at a coordinate c=(x,y)εC and within a radius r>0 in image I. This measure provides the standard deviation of the hue values of all objects that are within Euclidean distance r or less from coordinate c. Since the color wheel is cyclic it is not possible to employ the straightforward definition of standard deviation. Instead, we exploit an alternative definition of standard deviation that is computed in two steps. First, given a collection of hues hᵢεH, an average hue μ is calculated as the value that has the minimum sum of distances to all hues in H:

$$μ = {arg min}_{μ} {\sum }_{i} ‖ {h}_{i} - μ ‖ , \qquad ( 1 )$$

where ‘arg min’ is used to denote the value of μ for which the value of the given expression attains its minimum value, and brackets ∥ ∥ indicate absolute value. In the second step the cyclic standard deviation is defined as:

$${σ}_{c , r} ( I ) = \frac{1}{N} {\sum }_{i = 1}^{N} ‖ {h}_{i} - μ ‖ , \qquad ( 2 )$$

where N=|H| is the number of hues in the collection H over which the average is calculated.

On the basis of the hue standard deviation value σ_{c,r}(I) at a radius r around a coordinate c in an image I, a measure of the color harmony H(I) of the image can be specified as follows:

$$H ( I ) = \frac{1}{\vert C \vert} {\sum }_{c ∈ C} {\sum }_{r ∈ [ 1 , R ]} \frac{{σ}_{c , r} ( I )}{{r}^{α}} \qquad ( 3 )$$

where C is the collection of all coordinates in/over which the harmony measure is to be calculated, R is the maximum distance between two coordinates in C, and α is a parameter that typically takes a value of 1. Examination of the harmony measure H(I) indicates that in order to achieve harmony (corresponding to a low value of H(I)) the hue variability should be small in the close neighbourhood but it may turn to be larger when the radius of the neighbourhood increases.

In general, embodiments of the present invention relate to a computer implemented method for generating an image using analogous color schemes such as to optimise the harmony of the image.

### First Embodiment

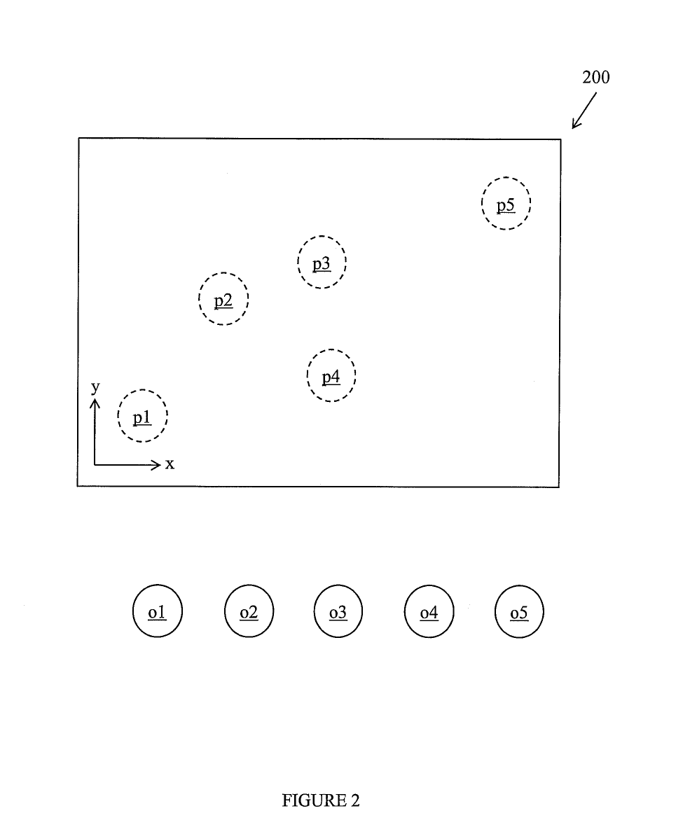

FIG. 2 shows an image 200 in accordance with a first embodiment of the present invention. The image 200 comprises a plurality of locations p1-p5 and a plurality of color objects o1-o5, wherein each color object is associated with a color and therefore a hue. In some embodiments the color object may comprise one or more pixels of the same hue, whereas in alternative embodiments a color object may comprise a plurality of pixels with differing hues. Where necessary, a suitable average hue for a color object can be calculated using standard techniques.

The task is to assign or map the plurality of color objects o1-o5 to the plurality of locations p1-p5 such that the harmony of the resulting image is optimised. In the present embodiment the image does not contain color entities in the image (or at least color entities are ignored for the purposes of locating the color objects o1-o5) so the problem is termed an unconstrained problem. This problem can be expressed mathematically as the following color assignment problem:

Given are an image I and a set of objects oεO that have to be assigned to a group of locations pεP (indices [symbol] × [symbol] ), wherein each object oεo has a hue hₒε [symbol] mod 2 π, assign the color objects in O into locations in P such that the harmony measure H(I) is minimized.

Whilst it is straightforward to arrange color objects in a harmonic fashion along a single dimension, it is generally more difficult to arrange color objects for general two dimensional images. This is mainly due to the fact that there is a linear ordering for one dimension but not for two dimensions. Hence, the hue values can easily be assigned in harmonic fashion along a straight line. On the other hand this task is more challenging for two dimensional images, even for simple harmony metrics as illustrated in the present embodiment.

In the present embodiment, the color of each object oεO (o1-o5 in FIG. 2) is represented by a triplet of numbers (L*ₒ, a*ₒ,b*ₒ) that represents its coordinates in the CIELAB color space. Thus, the hue associated with each object is represented by the corresponding a*ₒ and b*ₒ values. It will be appreciated by the skilled person that the object color may be defined in any suitable color space, including but not limited to CIELUV, RGB, CMYK and the object hue may be specified accordingly. Similarly, each location pεP (p1-p5 in FIG. 2) is associated with a coordinate (xₚ,yₚ) representing a position in image I (200 in FIG. 2).

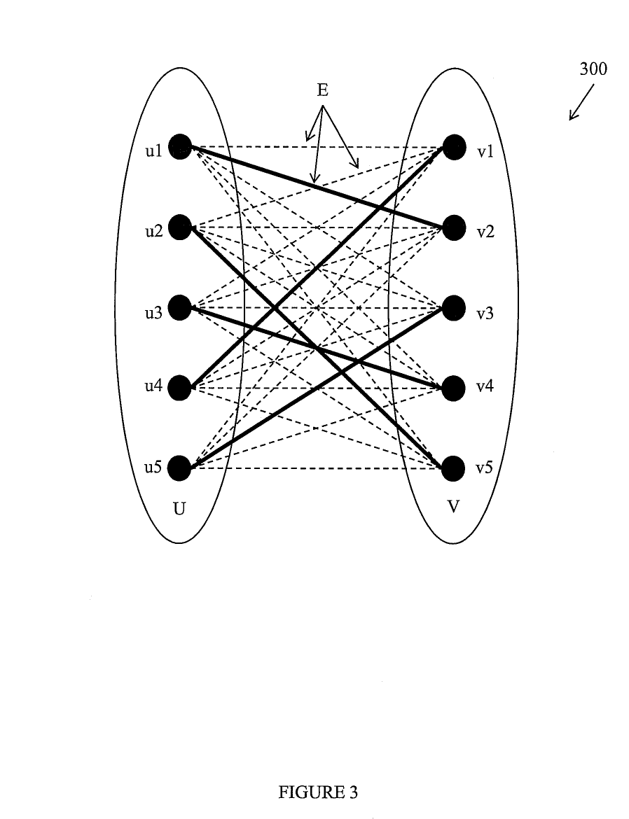

In the present embodiment, objects O are assigned to the locations P using a bipartite matching method. FIG. 3 shows a balanced bipartite graph 300 G(V,U,E) in accordance with the present embodiment. Each object oεO (o1-o5 in FIG. 2) is assigned to a corresponding node uₒεU (u1-u5 in FIG. 3). Similarly, each possible location pεP (p1-p5 in FIG. 2) is assigned to a node vₚεV (v1 to v5 in FIG. 3). Finally, an edge eₒₚεE linking nodes in U to nodes in V is defined. FIG. 3 shows an example where each node in U is linked to each node in V, each edge representing a possible assignment of an object oεO to a location pεP. It will be apparent to a skilled person that in some embodiments it may be desirable to include additional constraints (for example, a reduced set of possible locations for a particular object), and that additional constraints may be incorporated by removing edge assignments as appropriate. Each possible assignment of a color object to a location may be termed a possible object-location pair.

The values a*ₒ, b*ₒ and xₚ,yₚ for each object o and position p respectively are normalised to the interval [0,1], using for example the identity function to provide normalised values ã*ₒ, \tilde{b}*ₒ and \tilde{x}ₚ, \tilde{y}ₚ. For example, normalised values ã*ₒ, \tilde{b}*ₒ and \tilde{x}ₚ, \tilde{y}ₚ may be calculated as follows:

$$\begin{matrix}{\tilde{a}}_{o}^{*} = \frac{{a}_{o}^{*}}{{max}_{o ∈ O} \{ {a}_{o}^{*} \}} for each object o ∈ O , & ( 4 ) \\ {\tilde{b}}_{o}^{*} = \frac{{b}_{0}^{*}}{{max}_{o ∈ O} \{ {b}_{o}^{*} \}} for each object o ∈ O , & ( 5 ) \\ {\tilde{x}}_{p} = \frac{{x}_{p}}{{max}_{p ∈ P} \{ {x}_{p} \}} for each location p ∈ P , & ( 6 ) \\ {\tilde{y}}_{p} = \frac{{y}_{p}}{{max}_{p ∈ P} \{ {y}_{p} \}} for each location p ∈ P . & ( 7 )\end{matrix}$$

Next, a weighting for each of the edges wₒₚεW is defined. Given an edge that connects between an object node uₒεU to a location node vₚεV the weight wₒₚεW over the corresponding edge eₒₚεE is calculated as follows:

wₒₚ=(ã*ₒ−\tilde{x}ₚ)²+(\tilde{b}*ₒ−\tilde{y}ₚ)². (8)

In the next step it is necessary to find the optimum assignment of object nodes uₒεU to location nodes vₚεV such that the sum of weights over the assigned edges is minimised (and thus the harmony measure is minimised). The resulting assignment may be termed the harmonic object location pairs. This assignment problem can be achieved using a minimum weight matching algorithm (for example, the Bellman-Ford algorithm or any other suitable algorithm as is known in the prior art). The time complexity for complete balanced bipartite graphs is O(N³), where N is the number of nodes in the bipartite graph. Therefore, in the present case this translates to O(|O|³), where |O|³ is the cardinality of the group of color objects O. An example set of harmonic object-location pairs forming an example optimum solution are shown as bold lines linking nodes U to nodes V in FIG. 3.

Once a solution to the assignment problem has been obtained, each color object oεO (o1-o5 in FIG. 2) is placed in the image/at the location pεP (p1-p5 in FIG. 2) corresponding to the determined harmonic object-location pairs to produce a harmonic image. In the present embodiment, the optimum assignment will correspond to color objects with small values of a*ₒ, b*ₒ being assigned to locations with small xₚ, yₚ. Hence color objects with similar hue will be assigned in proximity to each other in accordance with an analogous color scheme.

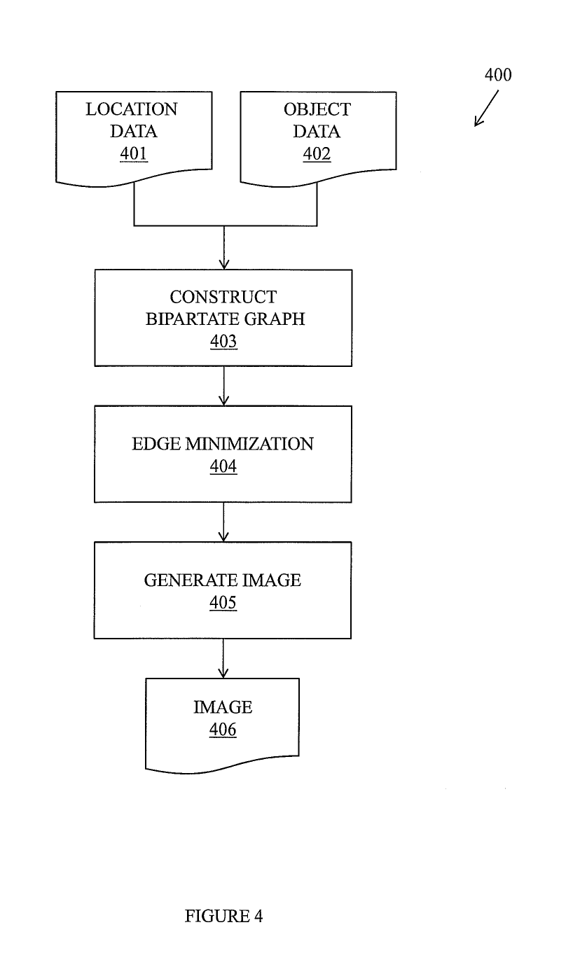

FIG. 4 shows a flow diagram illustrating a computer implemented method 400 of generating an image in accordance with the first embodiment of the invention. First, a bipartite graph is constructed based on location data 401 and object data 402 as discussed above [step 403] with appropriate edge weightings for each possible object-location pair. Next, a minimum weight matching algorithm is used to find the assignment corresponding to the maximum harmony [step 404] and finally the resulting assignment of harmonic object-location pairs is used to generate the image 406 [step 405]. It will be appreciated that, in certain embodiments of the present invention, it will not be necessary to explicitly generate the bipartite graph in graphical form, but an algebraic or symbolic form may be preferable from an efficiency perspective.

The hereinbefore described first embodiment of the invention provides a heuristic method for producing an image with a small harmony measure H(I) (thus producing a harmonic image) based on a bipartite graph method. However, it will be appreciated by those skilled in the art that the method does not produce an image that is mathematically guaranteed to minimise the harmony measure H(I) of the resulting image.

### Second Embodiment

In a second embodiment of the present invention, the color objects are assigned to locations such as to optimise color harmony with one or more color entities at fixed positions in the image. In this second embodiment the method comprises a first stage and second stage. In the first stage a spatial color distribution in the image is calculated based on the color entities, and in the second stage the color distribution is used to generate a corresponding bipartite graph which is used to assign color objects to areas in the image that share similar color hues.

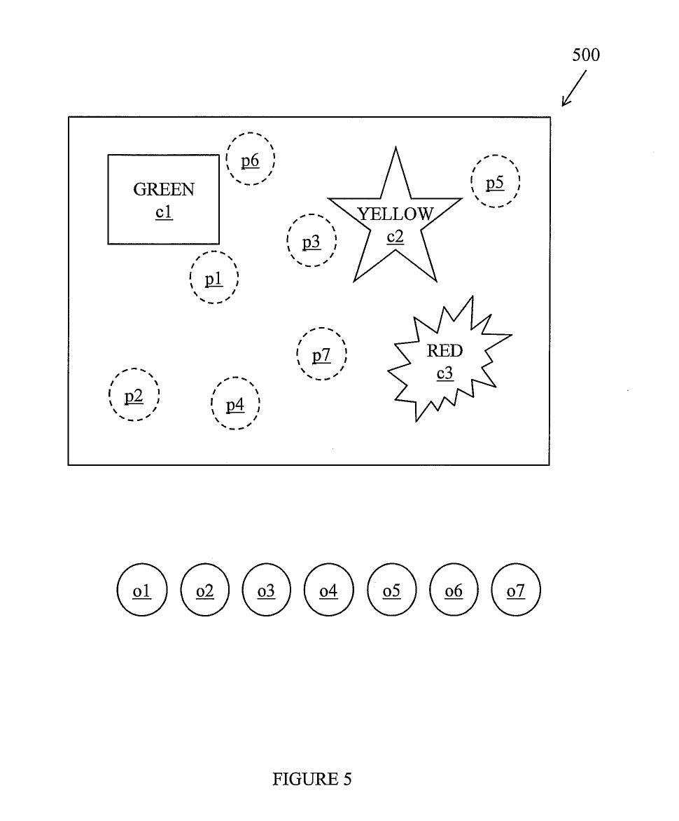

FIG. 5 shows an image 500 in accordance with a second embodiment of the present invention. The image 500 comprises a plurality of locations p1-p7, a plurality of color entities c1-c3 and a plurality of unassigned color objects o1-o7 of the kind described in reference to the first embodiment above. In some embodiments color entities c1-c3 may comprise one or more pixels of a single hue. Alternatively, a color entity may comprise a plurality of pixels of differing hue. In such embodiments a single hue value associated with a color entity may be calculated using a suitable averaging technique, or alternatively, the color entity may be divided into a number of smaller entities with single color hue.

The task associated with FIG. 5 is to assign the plurality of color objects o1-o7 to the plurality of locations p1-p7 such that the harmony of the resulting image is optimised in relation to the color entities c1-c3. Owing to the fact that the present embodiment contains color entities the problem is termed a constrained problem. This problem can be expressed mathematically as the following color assignment problem:

Given a set of objects oεO that have to be assigned to a group of locations pεP (indices in [symbol] × [symbol] ) in an image I comprising a set of color entities εC, wherein each object oεO and each color entity cεC has a hue h_{c}ε [symbol] mod 2π and hₒε [symbol] mod 2 π respectively, assign the color objects in O into locations in P (i.e., find an assignment from the object space O into the location space L) such that the harmonious measure H(I) is minimized.

Given a plurality of color entities of fixed position in the image (c1-c3 in FIG. 5), the mean hue hₚ at each location pεP of the image is calculated according to the following expression:

$${h}_{p} = \frac{{\sum }_{c ∈ C} {h}_{c} \cdot {d}_{p , c}^{- 1}}{{\sum }_{c ∈ C} {d}_{p , c}^{- 1}} \qquad ( 9 )$$

where d_{c} is the hue at a color entity c (in the limit the color entity may correspond to a single pixel), d_{p,c} is the distance from location p to c and C is the collection of all color entities in the image. The mean hue at each position hₚ is calculated only for locations that are in image I and are located within a radius of at most R from a color entity in the given image. Where |O|=|P|, the computation of this step requires O(|O|·N) operations, where N is the number of color entities in the image.

Next, the color objects are assigned to the locations according to the calculated spatial hue distribution. In other words, color objects are matched to areas in the image with similar colors hues. In this step, the assignment reflects only the distribution of hues across the image (due to the color entities). Given the set of all possible locations pεP, we consider only the locations that are within a radius R from a color entity in the given image. For example, referring to FIG. 5, locations p2 and p4 may be determined to fall outside a radius R from the color entities c1-c3 and will therefore not be considered in the assignment process. Locations located within radius R may be termed active locations and are denoted pₐεPₐ, whereas locations not with a radius R of a color object may be termed inactive locations are denoted pᵢεPᵢ. Determination of the optimum assignment of color objects to active locations pₐεPₐ (i.e. the harmonic object-location pairs) is achieved by defining a bipartite graph similar to the one that was constructed for the unconstraint case (first embodiment).

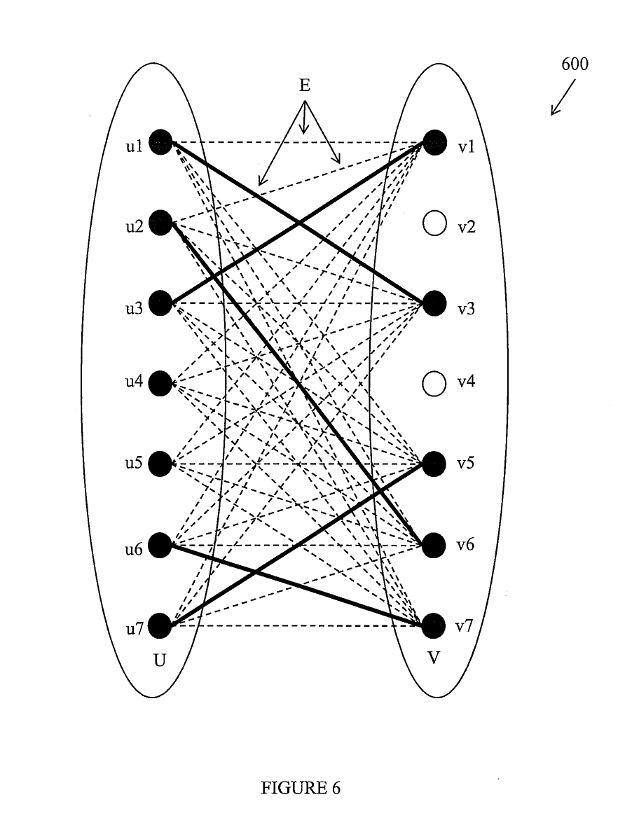

FIG. 6 shows an exemplary bipartite graph constructed in accordance with the present embodiment. The graph comprises nodes u1-u7 (corresponding to color objects o1-o7 in FIG. 5) and nodes v1-v7 (corresponding to locations p1-p7 in FIG. 5). A plurality of edges are shown connecting each node uₒεU to each node vₚεV however it will be apparent that where a position node corresponds to an inactive location (nodes v2 and v4 corresponding to locations p2 and p4 in FIG. 5) there are no connecting edges defined—only nodes corresponding to active locations may terminate an edge.

Each link in the bipartite graph connects a color object oεO and an active location pₐεPₐ. However, in contrast to the first embodiment, the weight for each edge is calculated as the distance between the hue of the object and the hue in the hue distribution map that was computed in the previous step for the corresponding active location. More specifically, given an edge that connects between an object node uₒεU to a location node vₚεV the weight wₒₚεW over the corresponding edge eₒₚεE is calculated as:

wₒₚ=(a*ₚ−a*ₒ)²+(b*ₚ−b*ₒ)² (10)

where a*ₚ and b*ₚ are the (L*,a*,b*) color coordinates in the computed color map at the active location (xₚ,yₚ). After the above construction, we can find an assignment of color objects to location using any minimum weight matching algorithm as discussed above in relation to the first embodiment. For convenience, the resulting assignment of harmonic object-location pairs is denoted as A. Referring to FIG. 6, the determined harmonic object-location pairs are indicated using bold lines to connect the respective nodes.

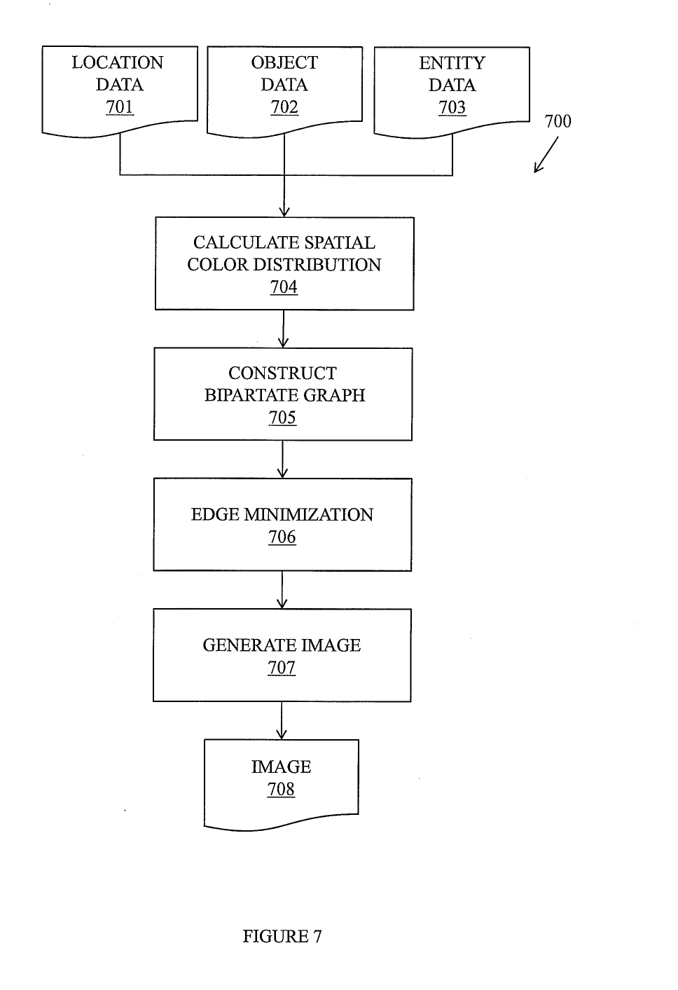

FIG. 7 shows a flow diagram illustrating a computer implemented method 700 of generating an image in accordance with the second embodiment of the invention. First, the spatial hue distribution is calculated [step 704] based on location data 701, object data 702 and entity data 703. Next, a bipartite graph is constructed as discussed above [step 705] with appropriate edge weightings. Next, a minimum weight matching algorithm is used to find the assignment corresponding to the maximum harmony [step 706] and finally the resulting assignment is used to generate the image 708 [step 707]. Again, it will be appreciated that in certain embodiments of the present invention, it will not be necessary to explicitly generate the bipartite graph in graphical form, but an algebraic or symbolic form may be preferable from an efficiency perspective.

### Third Embodiment

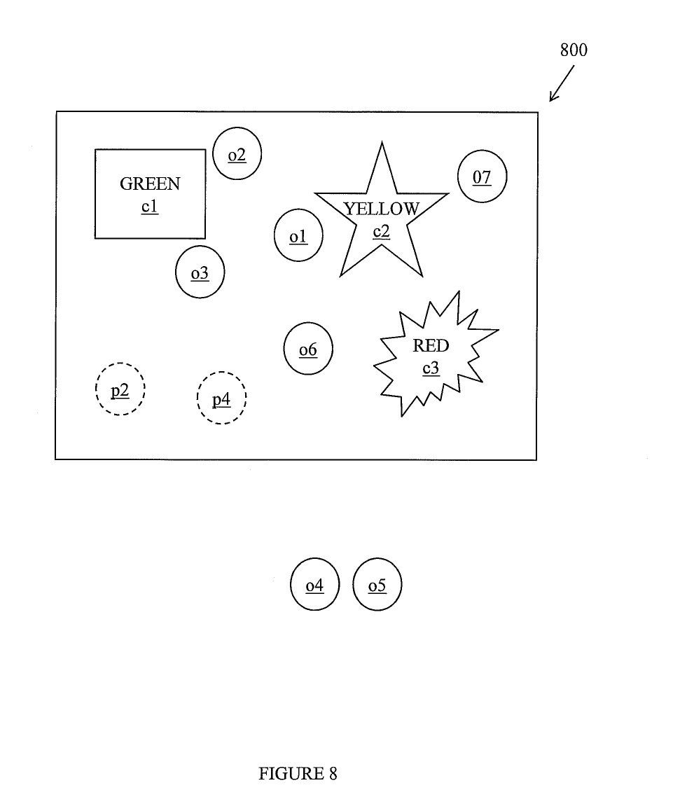

In the previously described embodiment, it is possible that the active locations are fewer than the number of color objects to be assigned. Thus, it is possible that following determination of the optimum assignment there will be one or more unassigned color objects (e.g. the object o4 and o5 corresponding to node u4 and u5 in FIG. 6). In a third embodiment of the present invention, the remaining unassigned color objects are harmoniously assigned to unassigned inactive locations pᵢεPᵢ (i.e. those not within a radius R of a color entity). FIG. 8 shows an image where color objects o1-o3, o6 and o7 have been assigned to the image according to the second embodiment, but color objects o4 and o5 remain unassigned to inactive positions p2 and p4. In order to assign color objects o4 and o5 a minimum cost circulation problem is introduced and defined as follows:

Given a network G(V,E) with a cost cₑ>0, lower bound lₑ>0 and upper bound uₑ>0 on the flow over each edge eεE, the goal is to find a flow F that satisfies the following constraints: (i) the flow over each link is between the lower and the upper bounds i.e., lₑ≦fₑ≦uₑ for each eεE; (ii) flow cannot appear or disappear at nodes i.e.,

$${\sum }_{e ∈ O ( v )} {f}_{e} = {\sum }_{e ∈ I ( v )} {f}_{e}$$

for each node vεV where O(v) and I(v) is the collection of all nodes that stem out and get into the node v respectively.

In the following, we exploit this solution to solve our problem as follows. As before we define two sets of nodes U and V where U corresponds to the set of all color objects and V corresponds to the set of all locations pεP. We assign an edge eₒₚεE between each node in U to each node in V with a capacity (i.e., upper bound on the flow) of one unit and a cost cₑ equal to the weight wₑ previously calculated (for example, see Equation 10). Consider now the assignment A that was computed in the second embodiment corresponding to the optimum assignment of color objects to active locations pₐεPₐ. In the present embodiment we set a lower bound of one flow unit over each edge that represents an assignment in A between an object oεO and a location pₐεPₐ. The lower bound lₑ is set to 1 for each assigned pair of objects oεO and location pεPₐ when A(o)=pₐ (otherwise, we set the lower bound to be zero). This requirement on the minimum flow implicitly states that the assignment defined by A is part of the final solution. Next, we designate a source node, s, connected to each of the nodes in U, and a sink node, t, connected to each of the nodes in V. An edge is defined between the two designated nodes s and t with a lower bound on the flow that equals to the number of objects that are to be assigned in the image (i.e., |O|). The minimum cost circulation problem has an efficient solution with a complexity of O(N³), where N is the number of network nodes. Therefore, the proposed algorithm solves the problem with a time complexity of O(|O|³). Any suitable maximum-flow algorithm, such as the Edmonds-Karp algorithm, may be used to obtain a solution.

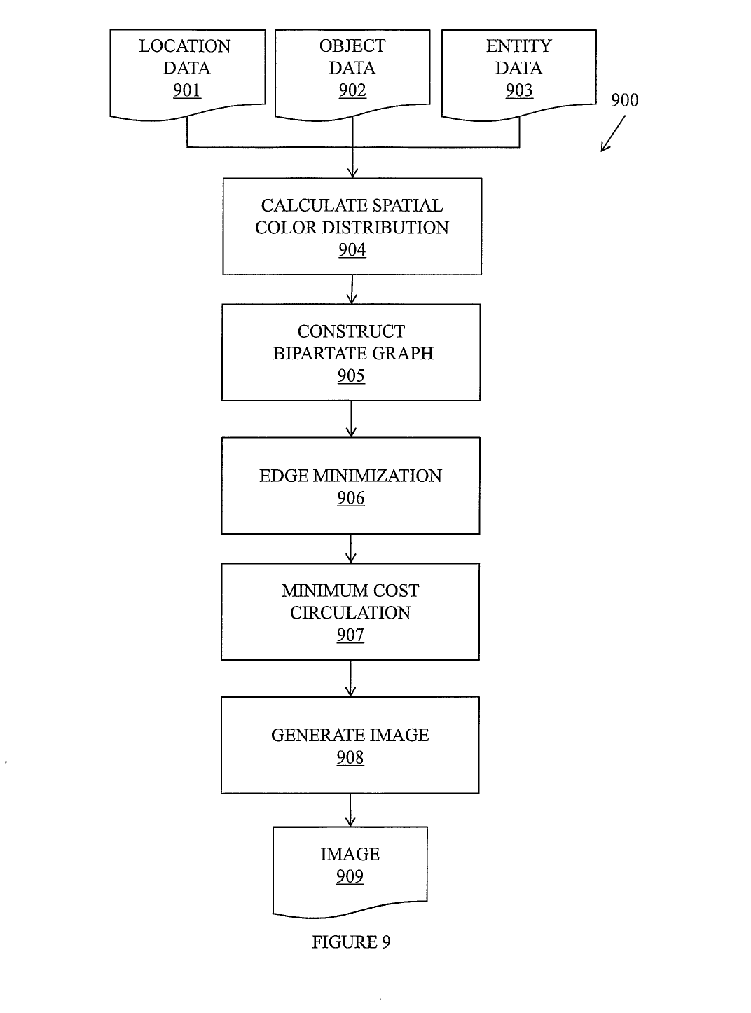

FIG. 9 shows a flow diagram illustrating a computer implemented method 900 of generating an image in accordance with the third embodiment of the invention. First, location data 901, object data 902 and entity data 903 is used to calculate the spatial hue distribution [step 904] and construct a bipartite graph as discussed above [step 905] with appropriate edge weightings. Next, a minimum weight matching algorithm is used to find the assignment corresponding to the maximum harmony for the active locations [step 906]. Following this the remaining unassigned color objects are assigned using the minimum cost circulation problem [step 907]. Finally, the image 909 is generated according to the determined harmonic assignment [step 908]. Again, it will be appreciated that in certain embodiments of the present invention, it will not be necessary to explicitly generate the bipartite graph in graphical form, but an algebraic or symbolic form may be preferable from an efficiency perspective.

### Fourth Embodiment

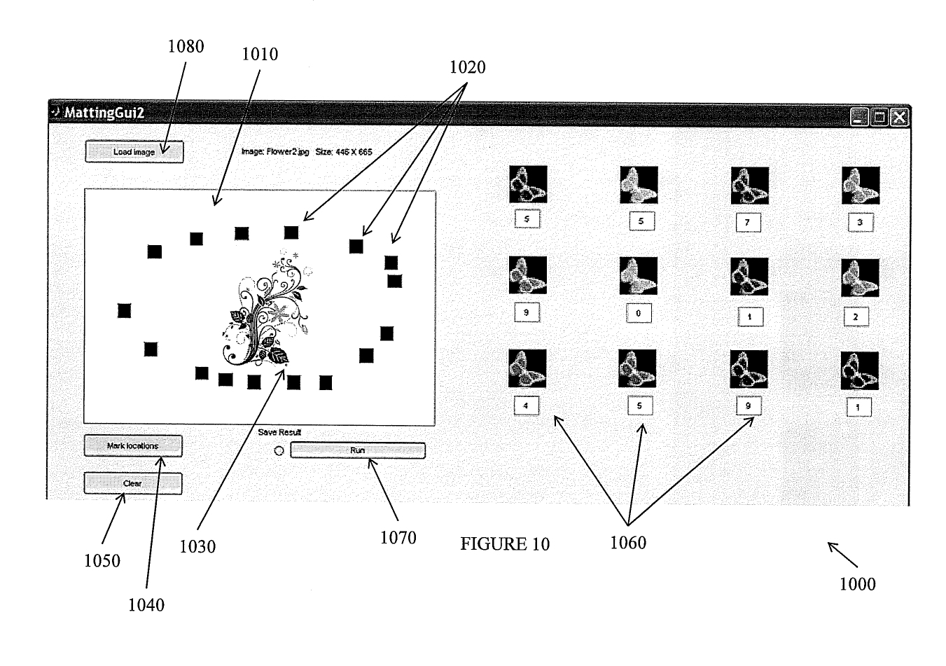

FIG. 10 shows a graphical user interface 1000 for constructing an image in accordance with embodiments of the present invention. The illustrated graphical user interface 1000 may be implemented, for example, on a personal computer with an attached display device such as an LCD monitor. Graphical user interface 1000 comprises a main area 1010 in which an image is displayed. The image may, for example, be loaded from an image file (including but not limited to PDF, JPEG, PNG and SVG image file types). Main area 1010 may also show one or more color entities such as color entity 1030. Such color entities may be pre-existing in the image or may be loaded separately from a separate image file. The user is able to mark a plurality of locations 1020 by pressing a ‘mark locations’ button 1040 and use his or her mouse to click a plurality of locations 1020 in area 1030. Also shown in FIG. 10 is a plurality of color objects 1060 to be assigned to locations 1020 according to an embodiment of the present invention. In the present embodiment, objects 1060 are pre-loaded but it will be apparent to a person of normal skill that the objects may be loaded by the user from one or more image files, downloaded from the Internet, or otherwise acquired using known techniques. The user selects the number of each color object to insert into the image at locations 1020 and then presses or clicks the ‘run’ button 1070. Upon clicking the ‘run’ button 1070, the plurality of color objects 1060 are assigned to locations 1020 using a method in accordance with the present invention (for example, the embodiments described hereinabove). Following harmonious assignment of the color objects 1060 to locations 1020, the user may save the resulting image as an image file, print the image using conventional printing techniques, or send the image via a wired or wireless network using any suitable protocol.

It will be appreciated that the embodiments of the present invention and the graphical user interface described hereinabove may be implemented using conventional computer hardware including but not limited to personal computers, mobile phones, personal digital assistants, or printing devices with display functionality. Embodiments of the invention may be implemented using hardware, firmware, software (for example, Java, Pascal, C#, C++, C, CGI, Perl, SQL, APIs, SDKs), or any appropriate combination of the three.

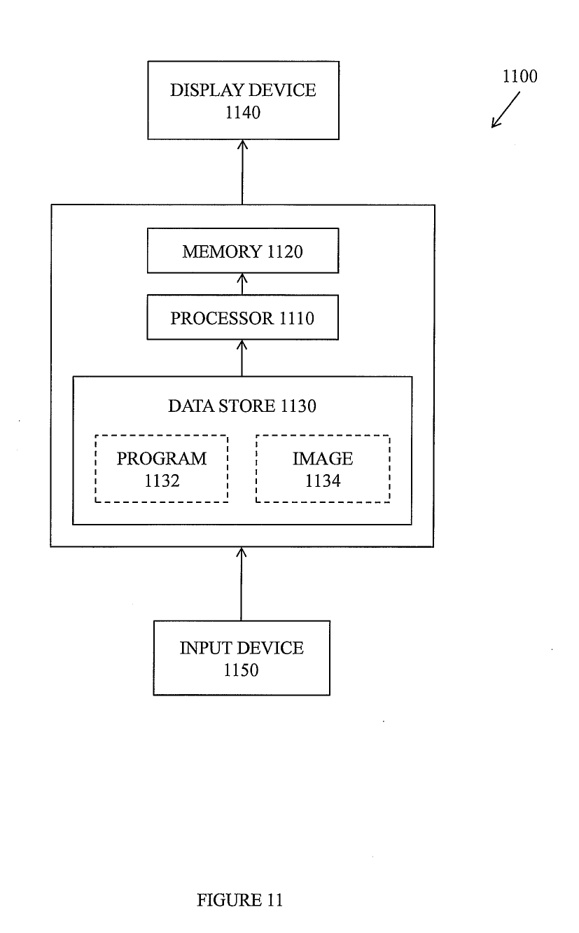

The methods described above may be implemented on a computing device, and example of which is shown in FIG. 11. Computing device 1100 comprises a display device 1140 suitable for displaying a GUI for generating the harmonic image. The computing device also comprises an input device 1150, such as a mouse and/or keyboard, which can be used by a user to operate the GUI as described above. The computing device further comprises a data store 1130 which will typically store program instructions 1132 to enact the methods described above, and data defining the image, colour objects and colour entities 1134 as appropriate. The image data 1134 may, for example, be acquired from a digital camera (not shown), the Internet via a suitable network connection (not shown) or otherwise acquired as is known in the art. A processor 1110 is adapted to read the program 1132 and image data 1134, which may be temporarily stored in memory 1120, and perform generate a harmonic image in response to commands from the user via input device 1150. The resulting harmonic image may be displayed using display device 1140, printed to hard copy or stored in digital form.

The invention further comprises a computer program or set of computer programs which when run on a suitable image processing system cause the system to implement the methods described above. The program or programs may be stored on carrier for example a computer readable storage medium. The storage medium may be a hard drive, tape, disc, or electronic storage device. The tape may be a magnetic tape. The disc may be an optical disc, a magnetic disc or a magneto-optical disc for example. The electronic storage may be a RAM, ROM, flash memory or any other volatile or non-volatile memory. The program may be on a carrier which may be a computer readable storage medium or a communication channel, or a signal.

The above embodiments are to be understood as illustrative examples of the invention. Further embodiments of the invention are envisaged. For example, the methods may be applied to vector images in addition to raster or bitmap images. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A computer implemented method of generating a harmonic image based on object data defining a plurality of objects to be located in the image, and location data defining a plurality of locations in the image, the method comprising the steps of:
determining a plurality of harmonic object-location pairs from a plurality of possible object-location pairs; and,
generating an image according to the determined harmonic object-location pairs.

2. A method according to claim 1, wherein each possible object-location pair is associated with a weighting factor, wₑ, and the harmonic object-location pairs are determined such as to minimise the sum of weighting factors.

3. A method according to claim 2, wherein the object data comprises color coordinates a*ₒ, b*ₒ, for an object o, and the location data comprises position coordinates xᵢ, yₚ, for a location p, and wherein the weighting factor, wₑ, for a possible object-location pair is calculated based on corresponding color coordinates a*ₒ, b*ₒ, and position coordinates xₚ,yₚ.

4. A method according to claim 3, wherein the weighting factor, wₑ, for a possible object-location pair is calculated as
wₒₚ=(ã*ₒ−\tilde{x}ₚ)²+(\tilde{b}*ₒ−\tilde{y}ₚ)²,
where ã*ₒ, \tilde{b}*ₒ, \tilde{x}ₚ and \tilde{y}ₚ are normalised values of a*ₒ, b*ₒ, xₚ and yₚ respectively.

5. A method according to claim 4 wherein the harmonic object-location pairs are determined using an edge minimisation algorithm.

6. A method according to claim 3, wherein the color coordinates are the color coordinates in CIELAB color space.

7. A method according to claim 3, wherein the image further comprises one or more color entities.

8. A method according to claim 7, wherein a colour entity comprises color coordinates and position coordinates.

9. A method according to claim 8, wherein the method further comprises the step of determining a spatial hue distribution based on the plurality of color entities, and determining the hue a*ₚ, b*ₚ at a corresponding location p according to the determined spatial hue distribution.

10. A method according to claim 9, wherein the weighting factor for a possible object-location pair is calculated as:
wₒₚ=(a*ₚ−a*ₒ)²+(b*ₚ−b*ₒ)².

11. A method according to claim 10 wherein the harmonic object-location pairs are determined using an edge minimisation algorithm.

12. A method according to claim 11, wherein following determination of the object-location pairs one or more color objects and one or more locations remain unassigned.

13. A method according to claim 12, wherein the one or more unassigned color objects are assigned to the one or more unassigned locations by determining the assignment corresponding to the minimum flow across the network, accounting for the object-location pairs determined by the edge minimisation algorithm.

14. A method according to claim 13, wherein the object-location pairs determined by the edge minimisation algorithm are accounted for by setting a minimum flow for the corresponding object-location pair.

15. A data carrier containing computer readable instructions for enacting a method of generating a harmonic image based on object data defining a plurality of objects to be located in the image, and location data defining a plurality of locations in the image, the method comprising the steps of:
determining a plurality of harmonic object-location pairs from a plurality of possible object-location pairs; and,
generating an image according to the determined harmonic object-location pairs.

16. A computer configured to carry out a method of generating a harmonic image based on object data defining a plurality of objects to be located in the image, and location data defining a plurality of locations in the image, the method comprising the steps of:
determining a plurality of harmonic object-location pairs from a plurality of possible object-location pairs; and,
generating an image according to the determined harmonic object-location pairs.
